(19) United States
(12) Patent Application Publication
(10) Pub. No.: US 2024/0134707 A1
(43) Pub. Date: Apr. 25, 2024

(54) APPARATUS, ARTICLES OF MANUFACTURE, AND METHODS FOR MANAGING PROCESSING UNITS

(71) Applicant: Intel Corporation, Santa Clara, CA (US)

(72) Inventors: Rajesh Poornachandran, Portland, OR (US); Kaushik Balasubramanian, Beaverton, OR (US); Karan Puttannaiah, Hillsboro, OR (US)

(21) Appl. No.: 18/548,072

(22) PCT Filed: Jun. 22, 2022
(86) PCT No.: PCT/US2022/034805

§ 371 Date: Aug. 24, 2023

Related U.S. Application Data
(60) Provisional application No. 63/222,938, filed on Jul. 16, 2021.

(51) Int. Cl. G06F 9/50; G06F 9/38; G06F 9/48

(52) U.S. Cl. CPC G06F 9/505; G06F 9/3877; G06F 9/4856

(57) ABSTRACT

Apparatus, articles of manufacture, and methods for managing processing units are disclosed. An example apparatus includes first processor circuitry to implement a central processing unit and second processor circuitry to perform at least one of first operations, second operations or third operations to obtain a resource request associated with a first workload; determine if a processing resource of a programmable network device is available to perform processing for the workload; determine if a second workload can be migrated from execution on the programmable network device; based on the determination that the second workload can be migrated, cause the second workload to be migrated; and cause the first workload to execute on the processing resource of the programmable network device.

### RELATED APPLICATION

This patent is a U.S. National Stage of International Application No. PCT/US2022/034805, filed Jun. 23, 2022, which claims priority to U.S. Patent Application No. 63/222,938, which was filed on Jul. 16, 2021. International Application No. PCT/US2022/034805 and U.S. Patent Application No. 63/222,938 are hereby incorporated herein by reference in their entirety. Priority to U.S. National Stage of International Application No. PCT/US2022/034805 and U.S. Patent Application No. 63/222,938 is hereby claimed.

### FIELD OF THE DISCLOSURE

This disclosure relates generally to computing systems and, more particularly, to apparatus, articles of manufacture, and methods for managing processing units.

### BACKGROUND

Evolutions in computing systems has led to the utilization of computing systems with many types of processing units. For example, the concept of XPU is directed to the utilization of application specific processing units that may be included in a computing system. For example, a computing system may include a general purpose processing unit, a graphics processing unit, and an artificial intelligence processing unit. An XPU is a cross-architecture computing solution that may be tied together in a single application programming interface (e.g., the oneAPI Standard Application Programming Interface), which manages the assignment of assigning each task to whichever processing unit is best suited to process it. For example, many cloud Service Providers (CSPs) are evolving their hardware platforms to disaggregated elements consisting of general-purpose processors, heterogeneous accelerators and purpose-built vertically integrated Infrastructure Processing Units (IPUs). Such processing units may be implemented by attached cards (e.g., peripheral control interconnect express (PCIE) attached cards), external processing units connected via a table (e.g., via a Thunderbolt port), via a motherboard-down (MB-down) solution soldered or otherwise attached to the motherboard, built into a central processing unit (CPU), etc.

### BRIEF DESCRIPTION OF THE DRAWINGS

FIG. 1 is a block diagram of an example architecture for supporting heterogenous computing.

FIG. 2 is a block diagram of an example architecture for infrastructure processing unit resource direction.

FIG. 3 is a flowchart representative of example machine readable instructions and/or example operations that may be executed and/or instantiated by processor circuitry to perform configuring using infrastructure processing unit resource direction.

FIG. 4 is a flowchart representative of example machine readable instructions and/or example operations that may be executed and/or instantiated by processor circuitry to conduct negotiation to dynamically allocate resources based on tolerances prescribed by an application and available IPU resources.

FIG. 5 illustrates an example environment in which resources managed by IPUs have various states of free and busy resources among CPU, GPU, SSD, etc.

FIG. 6 illustrates an example environment in which consensus in collaborative resource management is accomplished via a decentralized public block chain ledger.

FIG. 7 is a block diagram of an example processing platform including processor circuitry structured to execute the example machine readable instructions of one or more of FIGS. 3-4 to implement the example architecture of FIG. 1 and/or FIG. 2.

FIG. 8 is a block diagram of an example implementation of the processor circuitry of FIG. 7.

FIG. 9 is a block diagram of another example implementation of the processor circuitry of FIG. 7.

FIG. 10 is a block diagram of an example software distribution platform (e.g., one or more servers) to distribute software (e.g., software corresponding to the example machine readable instructions described herein) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

### DETAILED DESCRIPTION

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein “substantially real time” and “substantially simultaneously” refers to occurrence in a near instantaneous manner recognizing there may be real world delays for computing time, transmission, etc. Thus, unless otherwise specified, “substantially real time” and “substantially simultaneously” refer to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system (e.g., a computing system having one or more heterogenous processing unit(s)) including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry best suited to execute the computing task(s).

Computer components, such components that include processors, including heterogeneous processors, and/or other computer components may use firmware for booting, initialization, and/or operation. It is desirable to provide computer components and computers with multiple processing capabilities, such as graphics and/or artificial intelligence. It is also desirable to reduce the bill of materials (BoM) and/or cost of such computing systems. Apparatus, articles of manufacture, and methods are disclosed that facilitate sharing of resources among processors, such as CPUs, GPUs, AI chips, FPGAs, ASICs, microcontrollers (e.g., embedded microcontrollers), etc. Identifying the common and/or sharable resources among CPU and other processors in a heterogeneous processor platform (e.g., a platform including a CPU and discrete graphics) may reduce dedicated hardware usage at the platform, which may help to reduce BoM cost. Disclosed apparatus, articles of manufacture, and methods disclosed herein improve efficiency such as by reusing firmware and/or software (e.g., using a OneAPI library).

Some cloud Service Providers (CSPs) are evolving their hardware platforms to disaggregated elements consisting of general-purpose processors, heterogeneous accelerators and purpose-built vertically integrated Infrastructure Processing Units (IPUs), XPUs, DPUs, etc. Some resource management systems (RMS) (e.g., INTEL® RDT) operate on the realm of a CPU as the control point and managing server node level platform resources pivoted around the CPU. Such approaches may not be scalable or even applicable to IPU-hosted microservices-based infrastructure wherein the IPU become the control point. IPU-based systems are disrupting the way Data Center Resource Management systems operate (e.g., moving away from the CPU as the control point to disaggregated heterogenous self-manageable smart accelerators).

Apparatus, articles of manufacture, and methods disclosed herein facilitate the implementation of IPU resource management systems (IPURMS) that provide distributed services. In some examples, the proposed IPURMS provides decentralized peer-to-peer IPU resource negotiation and management without CPU centric involvement towards low latency micro-services. In some examples, the proposed IPURMS provides application aware resource management wherein IPUs can dynamically renegotiate RMS service level agreements (SLAs) for a variety of micro-services at run-time. In some examples, the proposed IPURMS facilitate IPUs P2P negotiations and resource management tracked via a decentralized distributed public ledger like blockchain with revocation capabilities to track/record telemetry with auditability. In some examples, the proposed IPURMS includes an IPU divided into two portions, namely i) data plane, and ii) control plane. The control plane handles resource allocation, monitoring and policy enforcement, and the data plane handles the data flow between IPUs and the logical units associated with the IPU.

A Deep Neural Network (DNN) Library (e.g., a oneAPI Deep Neural Network (oneDNN)) provides compute primitives to facilitate improved Deep Learning Performance on CPUs and GPUs with a uniform/same API developed for CPUs, GPUs, etc. or any combination. Existing DNN libraries detect underlying target hardware capabilities (e.g., INTEL® Deep Learning Boost technology) to accelerate inference/training performance. For example, oneDNN may utilize Just-in-Time (JIT) code generation and tries to choose instruction set architecture (ISA) or mix of ISA based on detected target hardware features. Even though this abstraction provides the capabilities to take advantage of the underlying hardware capability presents challenges. Apparatus, articles of manufacture, and methods disclosed herein provide a dynamic negotiable deep learning neural network library that facilitates a configurable and negotiable interface for application frameworks to specify SLA to configure JIT code generation params at run-time. Such systems may be policy configurable with or without platform Trusted Execution Environment (TEE) that can help to dynamically manage the Kernel in terms power, performance, energy efficiency, optimization in addition to pure capabilities of the hardware. Apparatus, articles of manufacture, and methods disclosed herein filter an implementation set of parameters to identify a candidate set based on application SLA and platform information. A corresponding JIT kernel may be dynamically generated for each from the candidate set. Apparatus, articles of manufacture, and methods disclosed herein may dry run the kernels one by one, pick out the one with best performance (e.g., Power/Energy Efficiency, TCO advantage, etc.), and cache it for later usage.

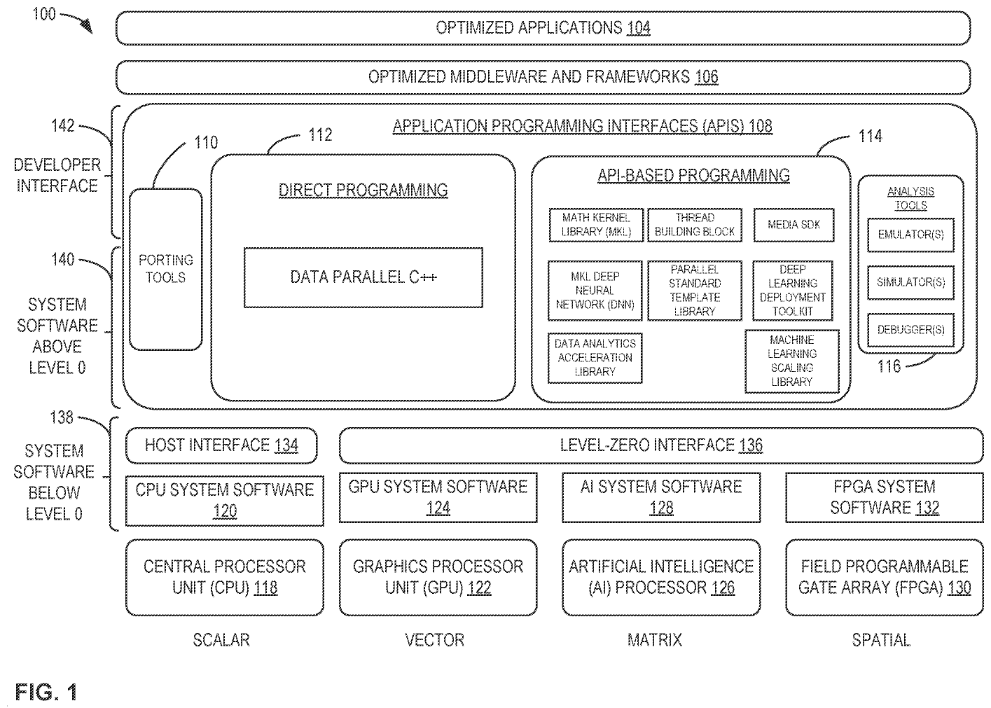

FIG. 1 is a block diagram of an example architecture 100 includes example optimized applications 104, example optimized middleware and frameworks 106, and example application programming interfaces (APIs) 108. In some examples, the optimized applications 104 can be implemented by applications (e.g., software applications, web- or browser-based applications, etc.) that are customized, tailored, and/or otherwise optimized to effectuate the identification and/or generation of a composable ML compute node. For example, the optimized applications 104 can be accessed, utilized, etc., by a developer (e.g., a software developer, a researcher, etc.), Information Technology (IT) personnel, etc. In some such examples, the optimized applications 104 can be accessed, utilized, etc., to co-design a hardware/software (HW/SW) solution for a technical problem that can benefit from AI/ML techniques. In some examples, the optimized middleware and frameworks 106 can be implemented by middleware and frameworks that are customized, tailored, and/or otherwise optimized to effectuate the identification and/or generation of a composable ML compute node. For example, the optimized middleware and frameworks 106 can implement an interface (e.g., communication, connectivity, etc.) between the optimized applications 104 and the APIs 108.

The APIs 108 of the illustrated example can be invoked to program, develop, and/or otherwise generate an AI/ML application by at least one of direct programming or API-based programming. The APIs 108 of the illustrated example include example porting tools 110, example direct programming APIs 112, example API-based programming APIs 114, and example analysis tools 116.

In some examples, the porting tools 110 can be implemented by software (e.g., a software application) that can adapt a program for the purpose of achieving some form of execution in a first computing or electronic environment that is different from a second computing or electronic environment for which the program was originally designed. For example, the porting tools 110 can convert and/or otherwise adapt a first program developed for a first type of hardware, operating system (OS), library, etc., into a second program for a second type of hardware, OS, library, etc.

In some examples, the direct programming APIs 112 can be invoked to effectuate direct programming tasks, which may include developing and/or compiling data parallel C++ applications. In some examples, the API-based programming APIs 114 can be invoked to effectuate API-based programming, which may include developing and/or compiling applications that call (or invoke, instantiate, etc.) a Math Kernel Library (MKL), an MKL Deep Neural Network (DNN) library, a data analytics acceleration library, a thread building block library, a parallel standard template library, a media software development kit (SDK), a deep learning deployment toolkit, a machine learning scaling library, etc., and/or any combination(s) thereof.

In some examples, the analysis tools 116 can be called, instantiated, and/or otherwise invoked to analyze hardware, software, and/or configuration(s) thereof of a composable ML compute node. For example, the analysis tools 116 can instantiate emulator(s) to emulate all of the hardware and/or software features of the composable ML compute node to generate and/or otherwise output one or more evaluation parameters. In some such examples, the evaluation parameters can include parameters representative and/or otherwise indicative of accuracy, latency, a number of cycles to complete a workload, or throughput of the composable ML compute node. In some examples, the evaluation parameters can include parameters representative and/or otherwise indicative of a processor or clock frequency, a fabric frequency, a read memory bandwidth, a write memory bandwidth, hardware de-rate factors, a number of memory ports, a number of data processing units (DPUs), a number of model layers (e.g., neural network layers, convolution layers, etc.) an activation precision (e.g., a precision of activation values to be processed), a weight precision (e.g., a precision of weight values to be processed), etc., and/or any combination(s) thereof. For example, the analysis tools 116 can execute an emulator based on the composable ML compute node. In some such examples, the analysis tools 116 can execute the emulator to determine a throughput of the composable ML compute node when the composable ML compute node executes a particular AI/ML model having a particular configuration.

In some examples, the analysis tools 116 can instantiate simulator(s) to simulate the behavior, the configuration, etc., of a composable ML compute node to generate and/or otherwise output one or more evaluation parameters. For example, the analysis tools 116 can execute a model (e.g., a simulation model, an AI/ML model, etc.) based on the composable ML compute node. In some such examples, the analysis tools 116 can execute the model to estimate, predict, and/or otherwise determine a throughput of the composable ML compute node when the composable ML compute node executes a particular AI/ML model having a particular configuration.

The architecture 100 of the illustrated example includes different types of hardware and/or software from which a composable ML compute node can be generated. In the illustrated example, the architecture 100 includes interfaces and target system software for scalar, vector, matrix, and spatial hardware. Additionally and/or alternatively, any other type of hardware may be used. In this example, the scalar hardware is implemented by an example CPU 118 and example CPU system software 120. For example, the CPU system software 120 can include instructions corresponding to a CPU Instruction Set Architecture (ISA). In this example, the vector hardware is implemented by an example GPU 122 and example GPU system software 124. For example, the GPU system software 124 can include kernels, portion(s) of code, etc., such as kernels, compute kernels, and/or shaders. In some examples, the kernels, the portion(s) of code), etc., can be represented in a high-level programming language such as, for example, a High-Level Shader Language (HLSL), OpenCL, etc.

In this example, the matrix hardware is implemented by an example AI processor 126 and example AI system software 128. For example, the AI system software 128 can include one or more AI/ML algorithms, models, etc., such as neural networks (e.g., convolution neural networks (CNNs), deep neural networks (DNNs), recurrent neural networks (RNNs), etc.), Linear Regression models, Logistic Regression Models, Decision Tree Models, Learning Vector Quantization Models, etc., and/or combination(s) thereof. In this example, the spatial hardware is implemented by an example FPGA 130 and example FPGA system software 132. For example, the FPGA system software 132 can include kernels, portion(s) of code, etc., based on a hardware description language (HDL) such as Verilog.

In the illustrated example, the CPU system software 120, the GPU system software 124, the AI system software 128, the FGPA system software 132, the host interface 134, and/or the level-zero interface 136 can correspond to and/or otherwise implement example system software below level zero 138. For example, system software below level zero 138 can correspond to and/or otherwise implement low-level direct-to-metal interfaces that are tailored to hardware, such as the CPU 118, the GPU 122, etc.

In the illustrated example, the APIs 108 can implement example system software above level zero 140 and an example developer interface 142. For example, a developer, a user, etc., can access and/or otherwise utilize the architecture 100 by way of the APIs 108. In some examples, a developer, a user, etc., can access and/or otherwise utilize system software at a higher level than low-level direct-to-metal interfaces by way of the APIs 108. In some examples, a developer, a user, etc., can access and/or otherwise utilize the system software below level zero 138 via the host interface 134 and/or the level-zero interface 136.

The architecture 100 is well-suited for facilitating efficient utilization of the hardware such as the CPU 118, the GPU 122, etc. by way of the APIs 108. For example, APIs may be added to the APIs 108 to facilitate and/or improve various processes. For example, disclosed example include APIs directed a set of library functions that may communicate with XPU hardware (e.g., to facilitate the sharing of firmware and software resources among processing units). In some disclosed examples, the APIs 108 may include platform components to support machine learning (e.g., a dynamic negotiable deep neural network platform). For example, the machine learning components of the APIs 108 may operate to improve the targeting of hardware capabilities to improve performance (e.g., improve deep learning inference performance). The disclosed API improvements (and other improvements disclosed herein) may be implemented separately and/or in combination. For example, the APIs 108 may include the APIs directed a set of library functions that may communicate with XPU hardware to facilitate the sharing of firmware and software resources among processing units and the APIs 108 may include the APIs to improve the targeting of hardware capabilities to improve deep learning inference performance. For example, the various improvements, when combined, may provide additive system performance increases and reduced BOM costs.

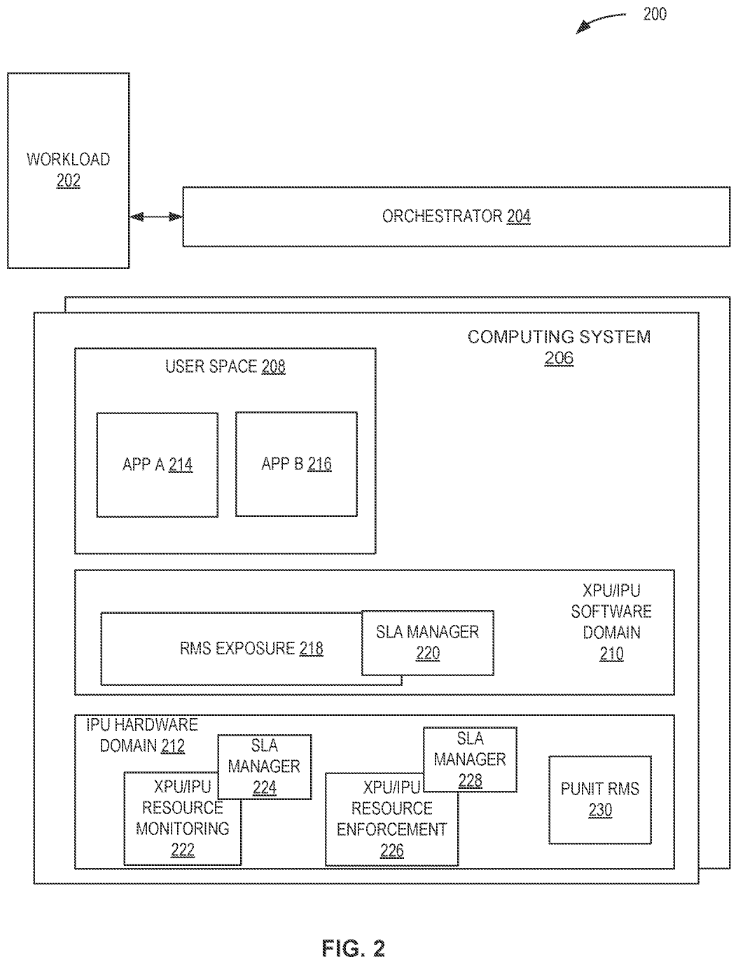

FIG. 2 is a block diagram of an example architecture 200 for IPURMS. Apparatus, articles of manufacture, and methods to implement an infrastructure processing unit resource directory technology (IPURMS) are disclosed. While reference is made to IPUs and an IPURMS by example, any type of processing unit (e.g., a processing unit to perform infrastructure operations, cloud service provider operations, etc. that is not the processing unit(s) to perform workload operations (e.g., implement a hypervisor, execute guest workloads, execute workloads of a tenant of a cloud services platform, etc.) and/or resource management technology may be utilized. The example IPURMS provides decentralized peer-to-peer IPU resource negotiation and management without CPU centric involvement to facilitate low latency micro-services and workloads such as VRAN, etc. In addition, the IPURMS provides application aware resource management wherein IPUs can dynamically renegotiate RMS SLAs for variety of micro-services at run-time. Furthermore, the IPURMS may facilitate IPUs P2P negotiations and resource management that may be tracked via decentralized distributed public ledger like blockchain with revocation capabilities (e.g., revocation management) to track/record telemetry with auditability. In addition, the IPURMS may facilitate an IPU that is divided into two portions, namely i) data plane, and ii) control plane, wherein the control plane handles resource allocation, monitoring and policy enforcement, and the data plane handles the data flow between IPUs and the logical units associated with the IPU.

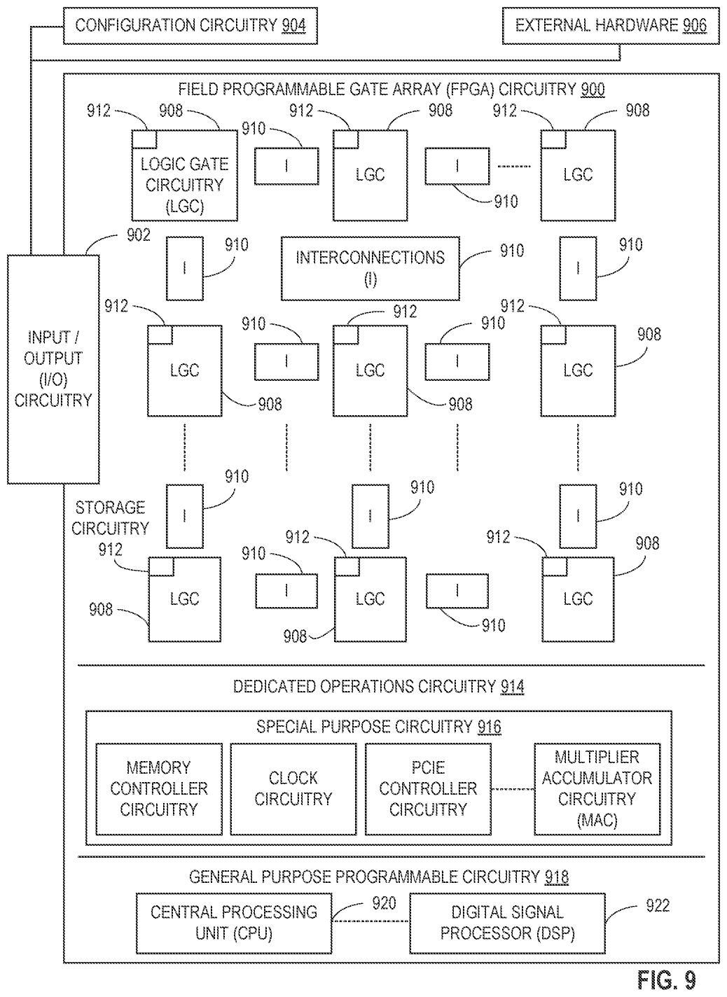

According to the illustrated example of FIG. 9, a new workload (or VM) 202 communicates with an example orchestrator 204 to request a system with a specific SLA. The example architecture 200 includes the orchestrator 204, an example user space 208, an example XPU/IPU software domain 208, and an example IPU hardware domain 210.

The example orchestrator 204 is server circuitry that negotiates with existing workloads for placement of the workloads on computing resources based on SLAs. The example orchestrator 204 communicates with one or more computing system(s) 206 to manage the assignment of workloads to computing resources.

The example computing resources 206 are represented by several abstractions including a user space 208, an XPU/IPU software domain 210, and an IPU hardware domain 212. The example user space 208 includes an application A 914 and an application B 216, though any number or type of application may be included. The example user space 208 is monitored by the orchestrator 204.

The example XPU/IPU software domain 210 includes an example RMS exposure 218 that is monitored by an example SLA manager 220. The example RMS exposure 218 facilitates the communication of application level information with the orchestrator 204.

The example IPU hardware domain 212 includes an example XPU/IPU resource monitoring 222 monitored by an example SLA manager 224, an example XPU/IPU resource enforcement 226 monitored by an example SLA manager 228, and a Punit RMS 230.

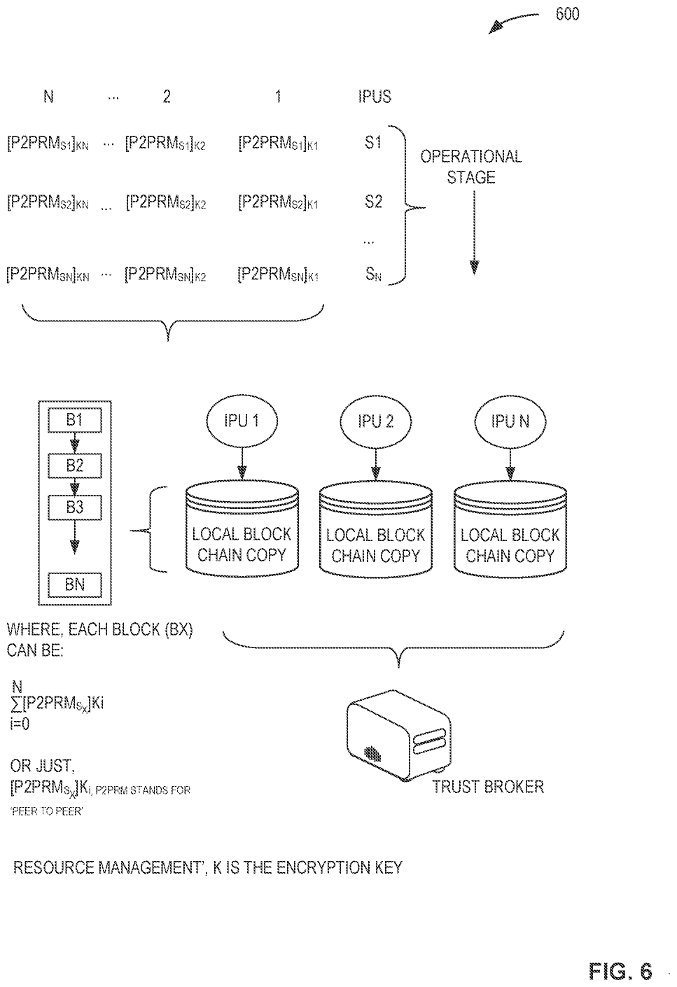

The example XPU/IPU resource monitoring 222 provides resource feedback to the example RMS exposure 218 while the example XPU/IPU resource monitoring 222 and the example XPU/IPU resource enforcement 226 communicate regarding hardware policies. The example RMS exposure 218 communicates QoS hints to the example XPU/IPU resource enforcement 226 and the example XPU/IPU resource enforcement 226 communicates with the Punit RMS 230 regarding QoS hardware features. The example architecture 200 facilitates a transition from CPU-centric, single node resource management to a scalable self-manageable XPU/IPU that can work in peer-to-peer collaboration. Consensus in such collaborative resource management may be accomplished via a centralized trust broker, a decentralized public ledger like block chain as illustrated in FIG. 6, etc.

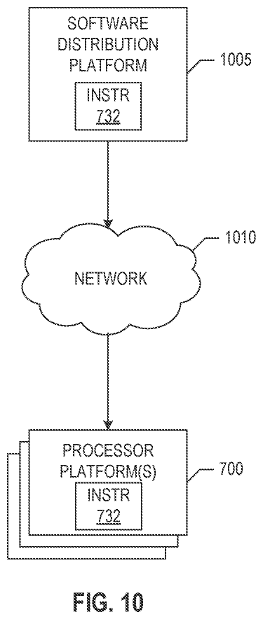

Flowcharts representative of example hardware logic circuitry, machine readable instructions, hardware implemented state machines, and/or any combination thereof for implementing unified firmware for the example architecture 200 is shown in FIG. 10 and FIG. 11. The machine readable instructions may be one or more executable programs or portion(s) of an executable program for execution by processor circuitry, such as the processor circuitry 712 shown in the example processor platform 700 discussed below in connection with FIG. 16 and/or the example processor circuitry discussed below in connection with FIGS. 48 and/or 49. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIG. 10 and FIG. 11, many other methods of implementing the example architecture 200 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

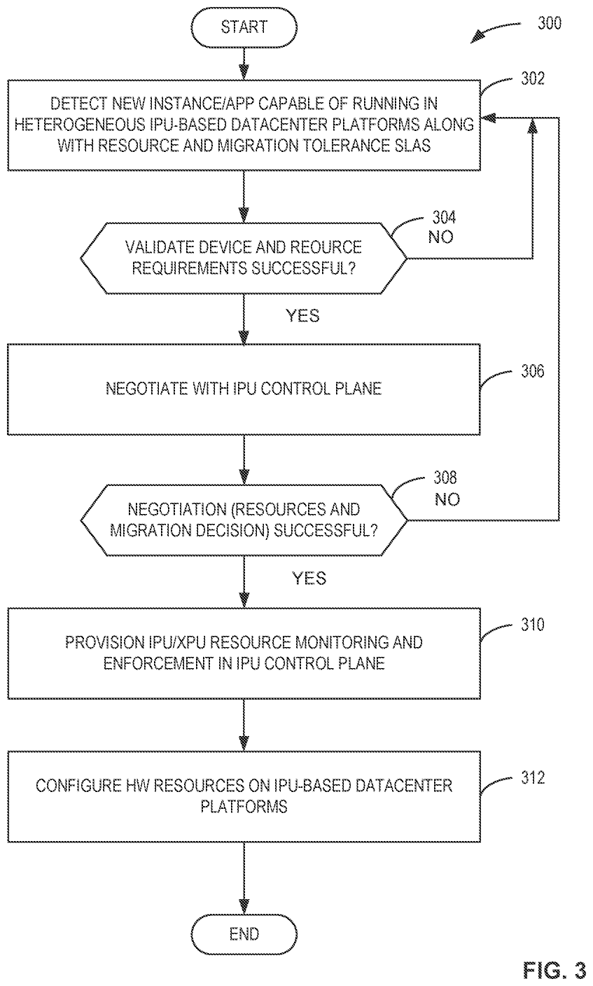

FIG. 3 is a flowchart representative of example machine readable instructions and/or example operations 300 that may be executed and/or instantiated by processor circuitry to perform configuring using IPURMS.

The machine readable instructions and/or the operations 300 of FIG. 3 begin at block 302, at which the example orchestrator 204 detects a new instance/application (e.g., workload 202) capable of running in a heterogenous IPU-based datacenter platform along with resource and migration tolerance SLAs. For example, the resource requirements and tolerance may be established by a user/administrator when creating the new instance/application (e.g., using an SLA template). The orchestrator 204 determines if validation of the device and resource requirements is successful (block 304). For example, the resource requirements may be analyzed to determine if they are feasible without the constraints of the computing system. If the resource requirements are not valid and/or not feasibly met by the computing system, the orchestrator 204 returns control to block 302.

If the resource requirements are valid (block 304), the orchestrator 204 negotiates with the IPU control plane to identify resource for performing the new instance/application (block 306). For example, based on the type of hardware resources specified in the request (e.g., CPU, GPU, FPGA and SSD), a set of IPUs corresponding to the specified resources are selected. Then, the negotiation between the new request and the existing Apps in the IPUs is started. For example, the negotiation may include making policy-based decisions using the identified resource tolerance thresholds and dynamically migrating existing workloads between IPUs to utilize all resources efficiently. Each IPU may include two portions, i) a data plane, and ii) a control plane. The control plane handles resource allocation, monitoring and policy enforcement, and the data plane handles the data flow between IPUs and the logical units associated with the IPU. An example process for negotiation is described in conjunction with FIG. 11.

The orchestrator 204 determines if negotiation was successful (block 308). For example, the negotiation may be determined to be successful if the orchestrator is able to find the necessary resources within the set of IPUs. For example, in one scenario, existing applications continue to run on the given IPUs, but there are additional resources free for the new application to be spun. In another scenario, the orchestrator 204 negotiates with an existing application and arranges for the application to be migrated to a different set of IPUs to free resources for the new instance/application.

If the negotiation is not successful (block 308), control returns to block 302 for the orchestrator 204 look for a different set of IPUs that satisfy the resource requirements.

If the negotiation is successful (block 308), the orchestrator 204 provisions the IPU/XPU resource monitoring and enforcement in the IPU control plane (block 310). Then, the orchestrator 204 configures the hardware resources on the IPU-based datacenter platform(s) for the new instance/application (block 312). Thus, the negotiation process among IPUs may enable cross-domain coordinated resource management at the datacenter level.

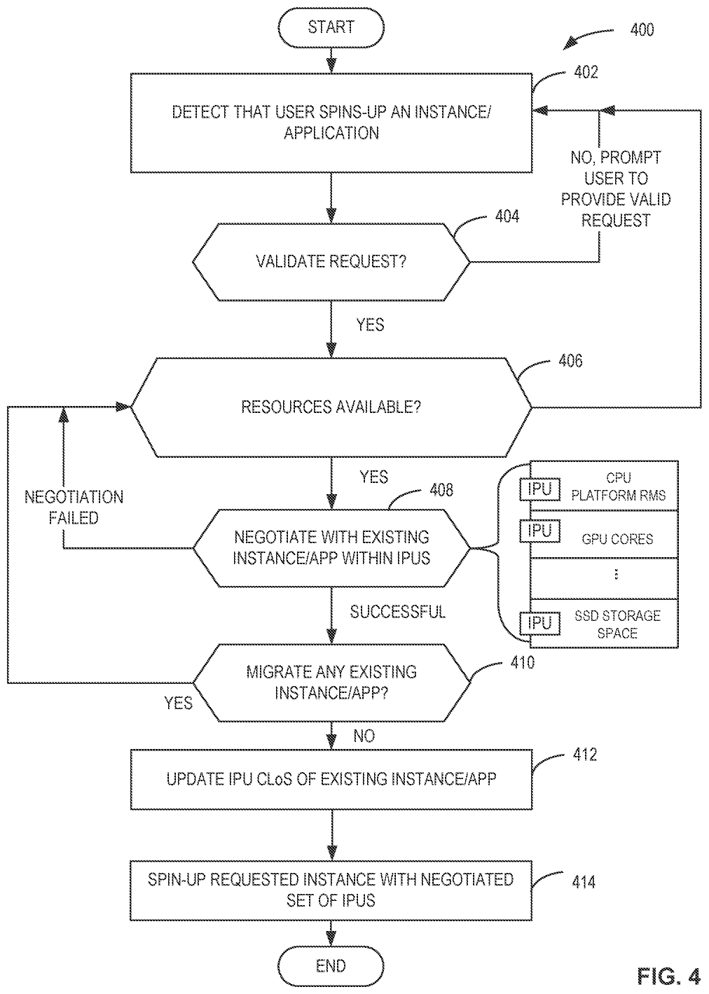

FIG. 4 is a flowchart representative of example machine readable instructions and/or example operations 400 that may be executed and/or instantiated by processor circuitry to conduct negotiation to dynamically allocate resources based on tolerances prescribed by an application and available IPU resources.

The machine readable instructions and/or the operations 400 of FIG. 4 begin at block 402, at which the orchestrator 204 detects that a user has spun up a new instance/application (e.g., a VM, an application, etc.). For example, the request may identify QoS parameters, SLA requirements, etc. For example, the QoS parameters may be set as QOS=FUNC(DEVICE REQS, FREQUENCY, CACHE, MEM-BW, POWER, IPC, CORES, STORAGE, MIGRATION-TOLERANCE). Specifying the SLA parameters enables the specification of hardware resources (e.g., CPU, GPU, FPGA, SSD and respective IPUs) within the datacenter. An example SLA template is specified as:
1. CPU:
   A. FREQUENCY RANGE
   B. MEMORY BANDWIDTH RANGE
   C. CACHE SIZE RANGE
   D. TDP RANGE
   E. CORE COUNT RANGE
   F. MIGRATION TOLERANCE
   G. XEON IPC RANGE
2. SSD STORAGE SPACE RANGE
3. GPU CORES RANGE
4. FPGA
5. PCIE GENERATION REQUIREMENT
6. IPU control plane management
   h. Network bandwidth range
   i. Queue prioritization

The orchestrator 204 validates the request for validity (block 404). If the request is not valid, the user is prompted to provide a valid request and control returns to block 402. If the request is valid (block 404), the orchestrator 204 determines availability of computing resources (block 406). If available computing resources (e.g., IPU resources) that are willing to negotiate are not available, control returns to block 402.

If available computing resources are determined that are willing to negotiate (block 406), the orchestrator 204 begins negotiating with existing instances/applications that are executing on the IPUs and determines if negotiation is successful (block 408). For example, negotiation may involve determining existing applications on an IPU that may tolerate lower resources to free resources for the new instance/application. Alternatively, negotiation may identify applications that may be migrated to other resources to free the selected resources for the new instance/application. If negotiation fails to free resources for the new instance/application, control returns to block 406 to identify different resources.

If negotiation succeeds in identifying available resources for execution of the new instance/application (block 408), the orchestrator 204 determines if there are existing instances/applications to be migrated off the resources (block 410). If there are existing instances/applications to be migrated, control returns to block 406 to manage negotiation and allocation of the existing instances/applications.

If existing application/instances are not to be migrated (block 410), the orchestrator 204 updates a resource allocator (e.g., Class of Service (CloS) of the existing instance/application (block 412). The orchestrator 204 spins-up the requested instance/application (e.g., workload 202) with the negotiated set of IPUs (block 414).

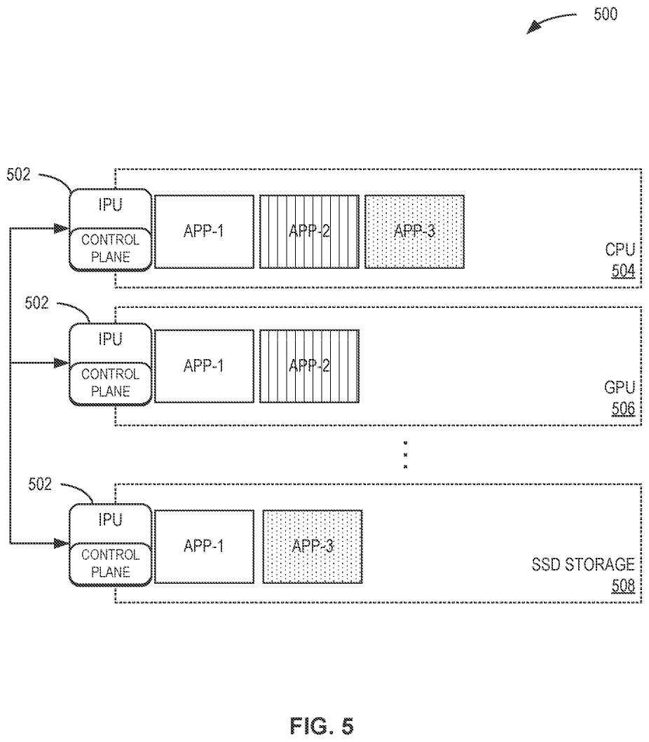

FIG. 5 illustrates an example environment 500 in which resources managed by IPUs 502 (or any type of processing unit such as XPU, GPU, etc.) have various states of free and busy resources among CPU 504, GPU 506, SSD 508, etc. According to the illustrated example, APP-1 is utilizing a portion of the CPU 504, the GPU 506, and the SSD Store 508, APP-2 is utilizing a portion of the CPU 504 and the GPU 506, and APP-3 is utilizing a portion of the CPU 504 and the SSD Storage 508.

FIG. 6 illustrates an example environment 600 in which consensus in collaborative resource management is accomplished via a decentralized public block chain ledger. As illustrated in FIG. 13, the operational states (e.g., state S₁, state S₂, state S_{N}) of several IPUs 1 to N. Thus, each block in a blockchain (e.g., blocks B₁ to B_{N}) can store state information that may be utilized for peer-to-peer resource negotiation. Utilizing such a blockchain facilitates a distributed collection of information that is trustable to effectively operate as a trust broker. While FIG. 2 illustrates a single centralized orchestrator 204, blockchain or other decentralized techniques may be utilized to facilitate a decentralized orchestrator that manages resources suing the control plane portion of the IPUs. In such a decentralized approach, the resource management can be tracked via the decentralized public ledger with revocation capabilities to track/record telemetry with auditability. Thus, the IPUs 502 can be considered to have computer resources as well as the management Intellectual Property (Ips) for the device associated with the IPU. The control plane of the IPU hosts the decentralized orchestrator that handles resource allocation, monitoring, and policy enforcement.

From the foregoing, it will be appreciated that example systems, methods, apparatus, and articles of manufacture have been disclosed for managing the assignment of resources in systems utilizing IPUs. Disclosed systems, methods, apparatus, and articles of manufacture improve the efficiency of using a computing device by improving IPU and ingredient resource utilization, manageability with auditability, secure metering towards improved total cost of ownership savings. Disclosed examples facilitate fine granular resource monitoring and manageability across IPUs in hyper scale data centers. Providing application-negotiable resource monitoring and management allows for dynamic prioritization to provide deterministic performance for at-scale microservices.

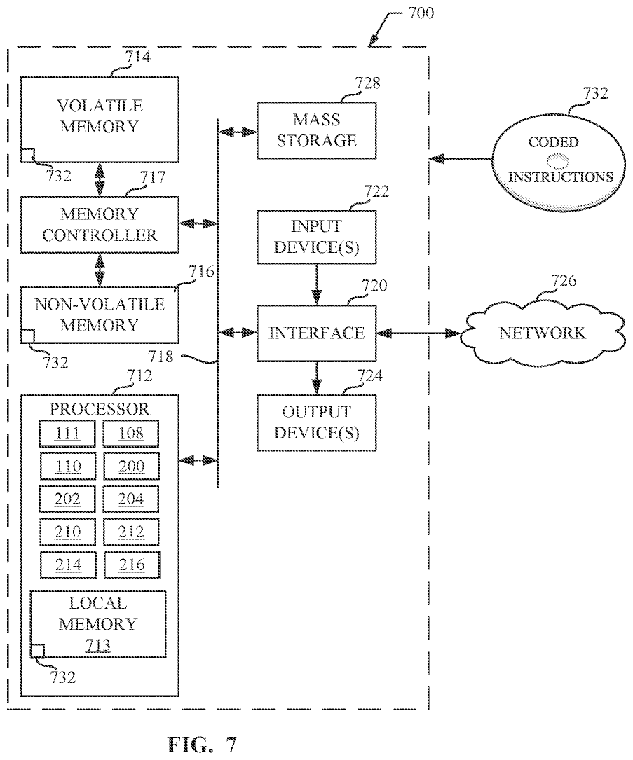

FIG. 7 is a block diagram of an example processor platform 700 structured to execute and/or instantiate the machine readable instructions and/or the operations of one or more of FIGS. 3-4 to implement resource management in an architecture such as the architecture 100 of FIG. 1. The processor platform 700 can be, for example, a server, a personal computer, a workstation, a self-learning machine (e.g., a neural network), a mobile device (e.g., a cell phone, a smart phone, a tablet such as an iPad™), a headset (e.g., an augmented reality (AR) headset, a virtual reality (VR) headset, etc.) or other wearable device, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs, microprocessors, CPUs, GPUs, DSPs, and/or microcontrollers from any desired family or manufacturer. The processor circuitry 712 may be implemented by one or more semiconductor based (e.g., silicon based) devices.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 732, which may be implemented by the machine readable instructions of FIGS. 3-4 may be stored in the mass storage device 728, in the volatile memory 714, in the non-volatile memory 716, and/or on a removable non-transitory computer readable storage medium such as a CD or DVD.

The processor platform 700 of the illustrated example of FIG. 16 includes example acceleration circuitry 734, which includes an example GPU 740, an example vision processing unit (VPU) 742, and an example neural network processor 744. Additionally and/or alternatively, the acceleration circuitry 734 may include any other type of hardware such as a CPU, an FPGA, an ASIC, etc. In this example, the GPU 740, the VPU 742, and the neural network processor 744 are in communication with different hardware of the processor platform 700, such as the volatile memory 714, the non-volatile memory 716, etc., via the bus 718. In this example, the neural network processor 744 may be implemented by one or more integrated circuits, logic circuits, microprocessors, GPUs, DSPs, or controllers from any desired family or manufacturer that can be used to execute an AI model, such as a neural network.

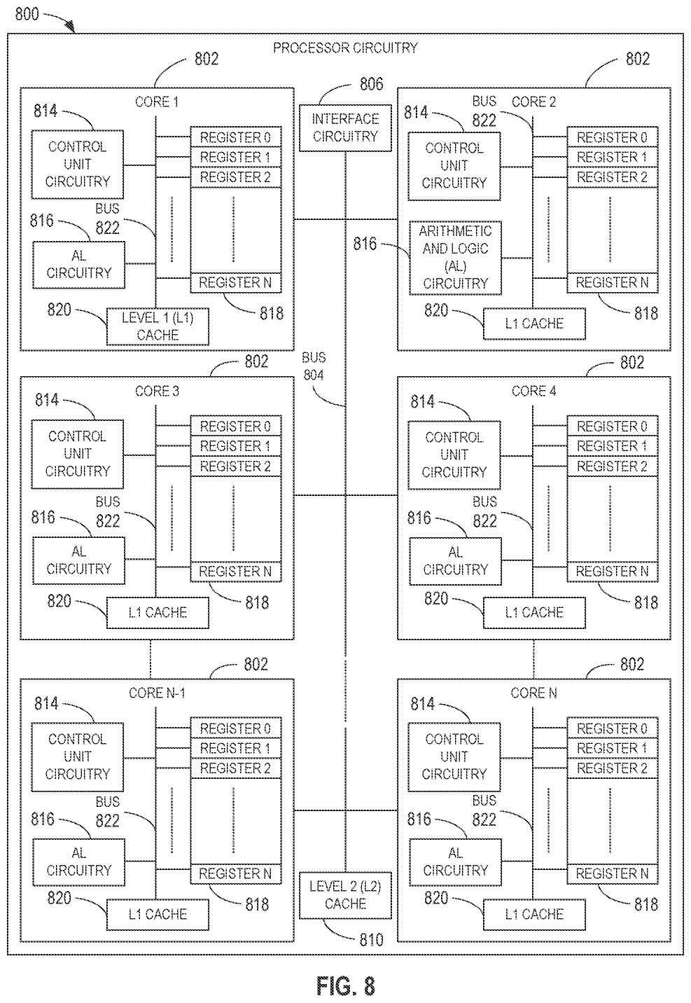

FIG. 8 is a block diagram of an example implementation of the processor circuitry 712 of FIG. 7. In this example, the processor circuitry 712 of FIG. 7 is implemented by a general purpose microprocessor 800. The general purpose microprocessor circuitry 800 executes some or all of the machine readable instructions of the flowcharts disclosed herein to effectively instantiate logic circuits to perform the operations corresponding to those machine readable instructions. For example, the microprocessor 800 may implement multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by one or more of the flowcharts disclosed herein.

The cores 802 may communicate by a first example bus 804. In some examples, the first bus 804 may implement a communication bus to effectuate communication associated with one(s) of the cores 802. For example, the first bus 804 may implement at least one of an Inter-Integrated Circuit (I2C) bus, a Serial Peripheral Interface (SPI) bus, a PCI bus, or a PCIe bus. Additionally or alternatively, the first bus 804 may implement any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2_ cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the L1 cache 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 48. Alternatively, the registers 818 may be organized in any other arrangement, format, or structure including distributed throughout the core 802 to shorten access time. The second bus 822 may implement at least one of an I2C bus, a SPI bus, a PCI bus, or a PCIe bus

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMS s), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 9 is a block diagram of another example implementation of the processor circuitry 712 of FIG. 7. In this example, the processor circuitry 712 of FIG. 7 is implemented by FPGA circuitry 900. The FPGA circuitry 900 can be used, for example, to perform operations that could otherwise be performed by the example microprocessor 800 of FIG. 48 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor 800 of FIG. 8 described above (which is a general purpose device that may be programmed to execute some or all of the machine readable instructions represented by the flowcharts disclosed herein but whose interconnections and logic circuitry are fixed once fabricated), the FPGA circuitry 900 of the example of FIG. 9 includes interconnections and logic circuitry that may be configured and/or interconnected in different ways after fabrication to instantiate, for example, some or all of the machine readable instructions represented by the flowcharts disclosed herein. In particular, the FPGA 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the software represented by the flowcharts disclosed herein. As such, the FPGA circuitry 900 may be structured to effectively instantiate some or all of the machine readable instructions of the flowcharts disclosed herein as dedicated logic circuits to perform the operations corresponding to those software instructions in a dedicated manner analogous to an ASIC. Therefore, the FPGA circuitry 900 may perform the operations corresponding to the some or all of the machine readable instructions disclosed herein faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware (e.g., external hardware circuitry) 706. For example, the configuration circuitry 704 may implement interface circuitry that may obtain machine readable instructions to configure the FPGA circuitry 900, or portion(s) thereof. In some such examples, the configuration circuitry 704 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 706 may implement the microprocessor 800 of FIG. 8. The FPGA circuitry 900 also includes an array of example logic gate circuitry 908, a plurality of example configurable interconnections 910, and example storage circuitry 912. The logic gate circuitry 908 and interconnections 910 are configurable to instantiate one or more operations that may correspond to at least some of the machine readable instructions of FIGS. 3-4 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 712 of FIG. 7, many other approaches are contemplated. For example, as mentioned above, modern FPGA circuitry may include an on-board CPU, such as one or more of the example CPU 920 of FIG. 9. Therefore, the processor circuitry 712 of FIG. 7 may additionally be implemented by combining the example microprocessor 800 of FIG. 8 and the example FPGA circuitry 900 of FIG. 9. In some such hybrid examples, a first portion of the machine readable instructions represented by the flowcharts of FIGS. 3-4 may be executed by one or more of the cores 802 of FIG. 8, a second portion of the machine readable instructions represented by the flowcharts of FIGS. 3-4 may be executed by the FPGA circuitry 900 of FIG. 9, and/or a third portion of the machine readable instructions represented by the flowcharts disclosed herein may be executed by an ASIC. Some or all of the circuitry may be instantiated, for example, in one or more threads executing concurrently and/or in series.

In some examples, the processor circuitry 712 of FIG. 7 may be in one or more packages. For example, the processor circuitry 800 of FIG. 8 and/or the FPGA circuitry 900 of FIG. 9 may be in one or more packages. In some examples, an XPU may be implemented by the processor circuitry 712 of FIG. 7, which may be in one or more packages. For example, the XPU may include a CPU in one package, a DSP in another package, a GPU in yet another package, and an FPGA in still yet another package.

A block diagram illustrating an example software distribution platform 1005 to distribute software such as the example machine readable instructions 732 or machine readable instructions of one or more of FIGS. 3-4 to hardware devices owned and/or operated by third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of the flowcharts disclosed herein, as described above. The one or more servers of the example software distribution platform 1005 are in communication with a network 1010, which may correspond to any one or more of the Internet and/or any of the example networks 726 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of the flowcharts disclosed herein, may be downloaded to the example processor platform 700, which is to execute the machine readable instructions. In some example, one or more servers of the software distribution platform 1005 periodically offer, transmit, and/or force updates to the software (e.g., the example machine readable instructions 732) to ensure improvements, patches, updates, etc., are distributed and applied to the software at the end user devices.

Example methods, apparatus, systems, and articles of manufacture to managing processing units are disclosed herein. Further examples and combinations thereof include the following:

Example 1 includes an apparatus to manage a processing unit, the apparatus comprising first processor circuitry to implement a central processing unit, second processor circuitry including one or more of at least one of a central processing unit, a graphic processing unit or a digital signal processor, the at least one of the central processing unit, the graphic processing unit or the digital signal processor having control circuitry to control data movement within the second processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrated Circuitry (ASIC) including logic gate circuitry to perform one or more third operations, the second processor circuitry to perform at least one of the first operations, the second operations or the third operations to obtain a resource request associated with a first workload, determine if a processing resource of a programmable network device is available to process the first workload, determine if a second workload can be migrated from execution on the programmable network device, based on the determination that the second workload can be migrated, cause the second workload to be migrated, and cause the first workload to execute on the processing resource of the programmable network device.

Example 2 includes the apparatus as defined in example 1, wherein the second processor circuitry includes an infrastructure processing unit.

Example 3 includes the apparatus as defined in example 1, wherein the second processor circuitry is a component of a second programmable network device.

Example 4 includes the apparatus as defined in example 1, wherein the second processor circuitry is to manage resources associated with the first processing circuitry.

Example 5 includes the apparatus as defined in example 1, wherein the resource request specifies a type of processing resource to be utilized.

Example 6 includes the apparatus as defined in example 1, wherein the second processor circuitry is to update a class of service for the second workload.

Example 7 includes the apparatus as defined in example 1, wherein the second processor circuitry is to store an association of the first workload and the processing resource in a blockchain.

Example 8 includes a non-transitory computer readable medium comprising instructions that, when executed, cause a processor to at least obtain a resource request associated with a first virtual workload, determine if a computing resource of a programmable network device is available to process the first virtual workload, determine if a second workload can be migrated from execution on the programmable network device, based on the determination that the second workload can be migrated, cause the second workload to be migrated, and cause the first virtual workload to execute on the computing resource of the programmable network device.

Example 9 includes the non-transitory computer readable medium as defined in example 8, wherein the processor includes an infrastructure processing unit.

Example 10 includes the non-transitory computer readable medium as defined in example 8, wherein the processor is a component of a second programmable network device.

Example 11 includes the non-transitory computer readable medium as defined in example 8, wherein the processor is to manage resources associated with a processing circuitry.

Example 12 includes the non-transitory computer readable medium as defined in example 8, wherein the resource request specifies a type of computing resource to be utilized.

Example 13 includes the non-transitory computer readable medium as defined in example 8, wherein the instructions, when executed cause the processor to update a class of service for the second workload.

Example 14 includes the non-transitory computer readable medium as defined in example 8, wherein the instructions, when executed cause the processor to store an association of the first virtual workload and the computing resource in a blockchain.

Example 15 includes a method comprising obtaining a resource request associated with a first workload, determining if a processing resource of a programmable network device is available to process the first workload, determining if a second workload can be migrated from execution on the programmable network device, based on the determination that the second workload can be migrated, causing the second workload to be migrated, and causing the first workload to execute on the processing resource of the programmable network device.

Example 16 includes the method as defined in example 15, wherein the determination if the processing resource is available is performed by an infrastructure processing unit.

Example 17 includes the method as defined in example 15, wherein the determination if the processing resource is available is performed by a component of a second programmable network device.

Example 18 includes the method as defined in example 15, further comprising managing resources associated with a first processing circuitry.

Example 19 includes the method as defined in example 15, wherein the resource request specifies a type of processing resource to be utilized.

Example 20 includes the method as defined in example 15, further comprising updating a class of service for the second workload.

Example 21 includes the method as defined in example 15, further comprising storing an association of the first workload and the processing resource in a blockchain.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus to manage a processing unit, the apparatus comprising:
interface circuitry;
first processor circuitry to implement a central processing unit;
instructions;
second processor circuitry to at least one of instantiate or execute the instructions to:
obtain a resource request associated with a first workload;
determine if a processing resource of a programmable network device is available to process the first workload;
determine if a second workload can be migrated from execution on the programmable network device;
based on the determination that the second workload can be migrated, cause the second workload to be migrated; and
cause the first workload to execute on the processing resource of the programmable network device.

2. The apparatus as defined in claim 1, wherein the second processor circuitry includes an infrastructure processing unit.

3. The apparatus as defined in claim 1, wherein the second processor circuitry is a component of a second programmable network device.

4. The apparatus as defined in claim 1, wherein the second processor circuitry is to manage resources associated with the first processor circuitry.

5. The apparatus as defined in claim 1, wherein the resource request specifies a type of processing resource to be utilized.

6. The apparatus as defined in claim 1, wherein the second processor circuitry is to update a class of service for the second workload.

7. The apparatus as defined in claim 1, wherein the second processor circuitry is to store an association of the first workload and the processing resource in a blockchain.

8. A non-transitory computer readable medium comprising instructions that, when executed, cause a processor to at least:
obtain a resource request associated with a first virtual workload;
determine if a computing resource of a programmable network device is available to process the first virtual workload;
determine if a second workload can be migrated from execution on the programmable network device;
based on the determination that the second workload can be migrated, cause the second workload to be migrated; and
cause the first virtual workload to execute on the computing resource of the programmable network device.

9. The non-transitory computer readable medium as defined in claim 8, wherein the processor includes an infrastructure processing unit.

10. The non-transitory computer readable medium as defined in claim 8, wherein the processor is a component of a second programmable network device.

11. The non-transitory computer readable medium as defined in claim 8, wherein the processor is to manage resources associated with a processing circuitry.

12. The non-transitory computer readable medium as defined in claim 8, wherein the resource request specifies a type of computing resource to be utilized.

13. The non-transitory computer readable medium as defined in claim 8, wherein the instructions, when executed cause the processor to update a class of service for the second workload.

14. The non-transitory computer readable medium as defined in claim 8, wherein the instructions, when executed cause the processor to store an association of the first virtual workload and the computing resource in a blockchain.

15. A method comprising:
obtaining a resource request associated with a first workload;
determining if a processing resource of a programmable network device is available to process the first workload;
determining if a second workload can be migrated from execution on the programmable network device;
based on the determination that the second workload can be migrated, causing the second workload to be migrated; and
causing the first workload to execute on the processing resource of the programmable network device.

16. The method as defined in claim 15, wherein the determination if the processing resource is available is performed by an infrastructure processing unit.

17. The method as defined in claim 15, wherein the determination if the processing resource is available is performed by a component of a second programmable network device.

18. The method as defined in claim 15, further comprising managing resources associated with a first processing circuitry.

19. The method as defined in claim 15, wherein the resource request specifies a type of processing resource to be utilized.

20. The method as defined in claim 15, further comprising updating a class of service for the second workload.
